(19) United States
(12) Patent Application Publication
(10) Pub. No.: US 2024/0305118 A1
(43) Pub. Date: Sep. 12, 2024

(54) DISTRIBUTED POWER AND ENERGY STORAGE SYSTEM

(71) Applicant: VIRV, LLC, Denver, CO (US)

(72) Inventors: CHRISTA ZAHARIAS, Denver, CO (US); Nick HOLLAND, Denver, CO (US)

(21) Appl. No.: 18/597,641

(22) Filed: Mar. 6, 2024

Related U.S. Application Data
(60) Provisional application No. 63/450,319, filed on Mar. 6, 2023.

(51) Int. Cl. H02J 7/00; H02J 7/35; B60L 53/53

(52) U.S. Cl. CPC H02J 7/0045; H02J 7/0013; H02J 7/35; B60L 53/53; H02J 2207/20

(57) ABSTRACT

An electrical system for a power generation and energy storage device is provided. Specifically, the electrical system includes an electrical system configured to provide a system to provide a battery as a service platform.

### CROSS-REFERENCE TO RELATED APPLICATIONS

This application claims priority pursuant to 35 U.S.C. 119(e) to co-pending U.S. Provisional Patent Application Ser. No. 63/450,319, filed Mar. 6, 2023, the entire disclosure of which is incorporated herein by reference.

### FIELD OF THE INVENTION

The present invention relates generally to energy storage and generation systems. More specifically, the present invention is concerned with distributed power and energy storage systems for the temporary power market. The present invention relates to electric ground support equipment utilizing a modular battery systems and methods as a service platform. More particularly the power electronics contained within the battery packs, battery system, the and the modular battery systems and methods for a swappable modular system.

### BACKGROUND

With ongoing mandates for removal or reduction of carbon dioxide (CO2) output in the atmosphere, efforts have been focused industries responsible for the highest CO2 emitting industries where decarbonization technologies can have the greatest impact. For example, powered ground support equipment and fleets are vital to the loading and unloading of planes at every airport across the globe. The decarbonization of this fleet is being mandated by government agencies, airports, and airlines. Typical electrification of this fleet is achieved through existing electric vehicle battery park architecture. This architecture is large, extremely heavy and recharging of this type of vehicle is time consuming and requires a one charging port to one vehicle strategy. This strategy requires a massive capital investment in infrastructure and electrical distribution and charging stations located at gates, under terminals and any space that is available to accommodate charging. Implementing this type of charging strategy will also create millions of hours of downtime due to charging per airport. Due to these constraints' airports will not be able to fully decarbonize this fleet. There needs to be a less capital intensive, smaller space requirement and more intelligent charging strategy to decarbonize this fleet.

### SUMMARY

The present invention comprises inventions and systems related to the distributed power and energy storage for the temporary power market. In this electrical system, a battery device and system disclosed that provides a high-power and high-capacity electrical energy storage and generator system, with a form factor that creates a nimble, portable, and modular solution. The present invention provides a battery as a service platform consisting of individually swappable battery packs with a modular and/or mobile battery system, such as a battery taxi, and provides a centralized charging hub, which reduces capital investment in infrastructure, electrical distribution, reduces downtime from hours to minutes and eliminates capital expenditure by industry, such as airlines, for the battery packs within each piece of ground support equipment.

In some embodiments, the individual battery packs, or power units, are controlled by a DC to DC conversion system and battery management system. The power electronics provide charging and swapping flexibility over existing electric battery pack architecture. The modular nature of the battery packs reduce weight allow for enhanced monitoring and safety as well as providing standardization to industry that can accelerate decarbonization strategies.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

Embodiments of the present invention are described in detail below with reference to the attached drawing figures, wherein:

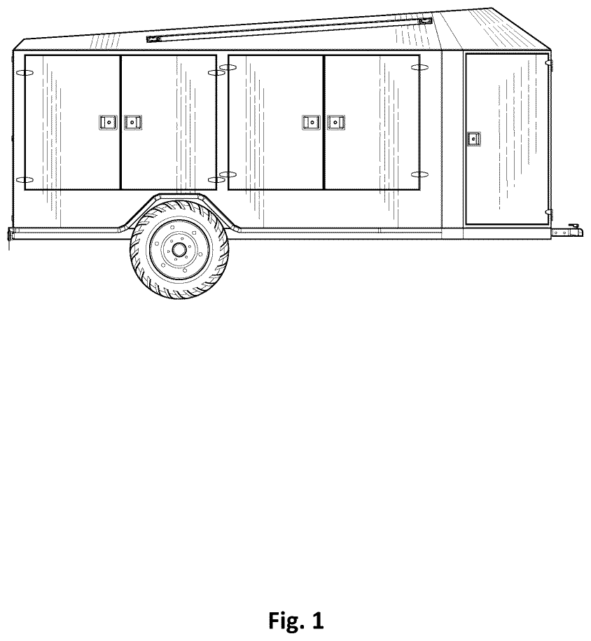

FIG. 1 shows a mobile energy storage and generation system of the present invention.

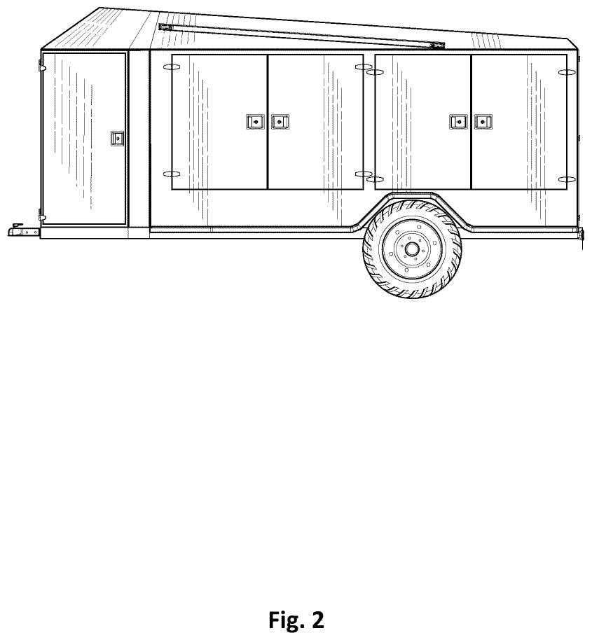

FIG. 2 shows a mobile energy storage and generation system of the present invention.

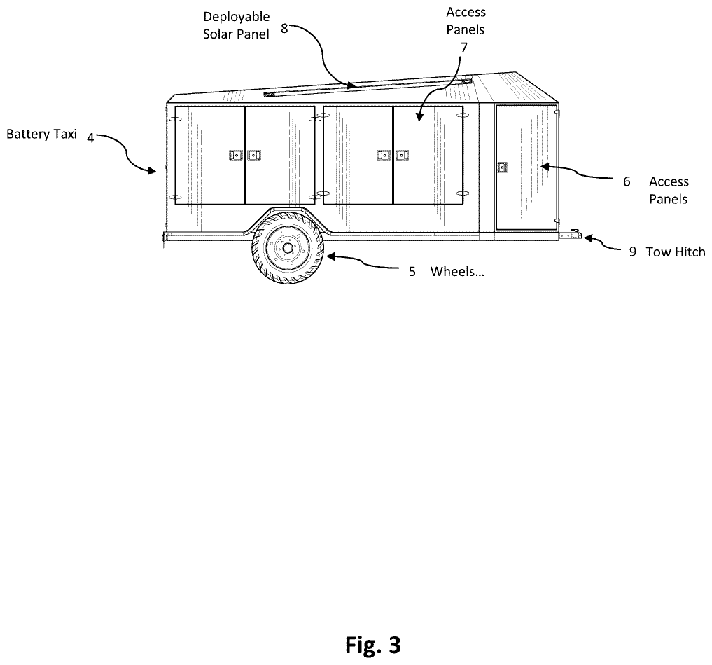

FIG. 3 shows a mobile energy storage and generation system of the present invention.

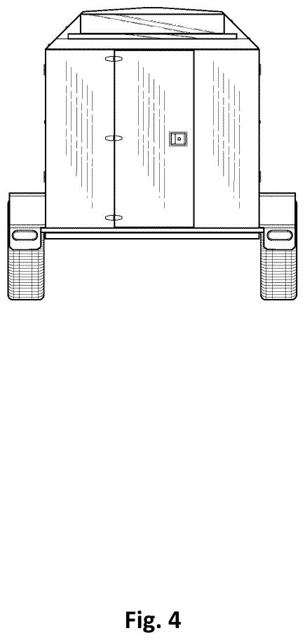

FIG. 4 shows a mobile energy storage and generation system of the present invention.

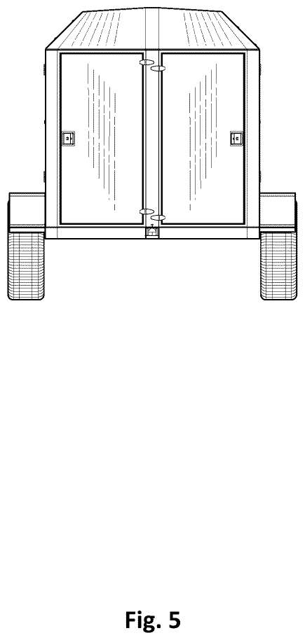

FIG. 5 shows a mobile energy storage and generation system of the present invention.

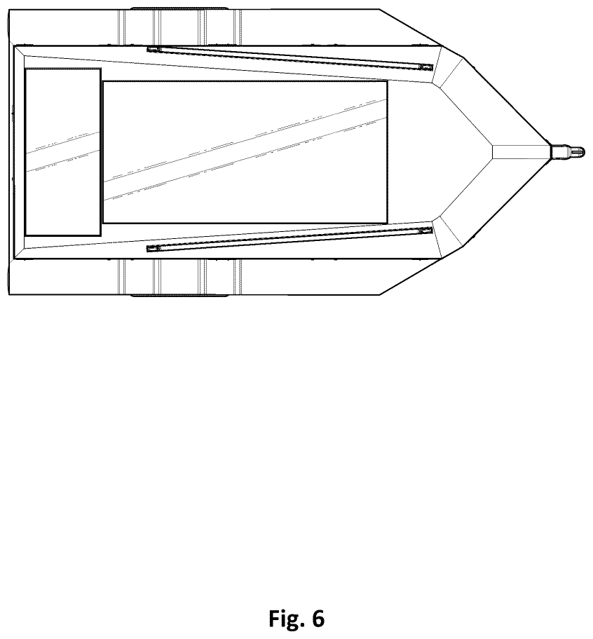

FIG. 6 shows a mobile energy storage and generation system of the present invention.

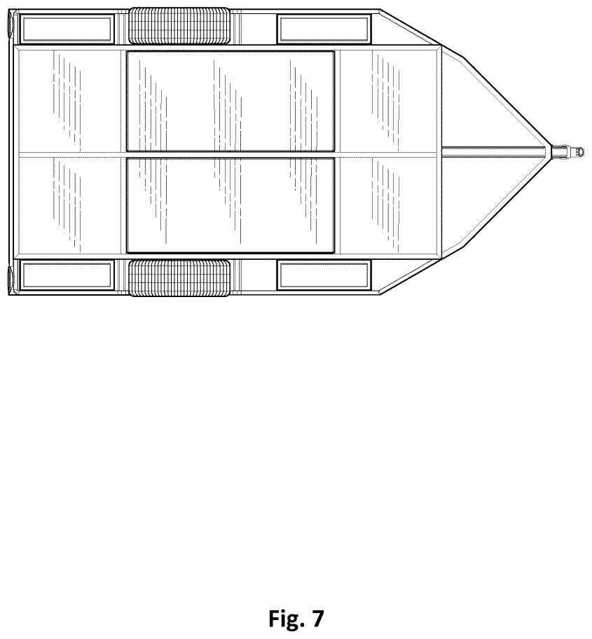

FIG. 7 shows a mobile energy storage and generation system of the present invention.

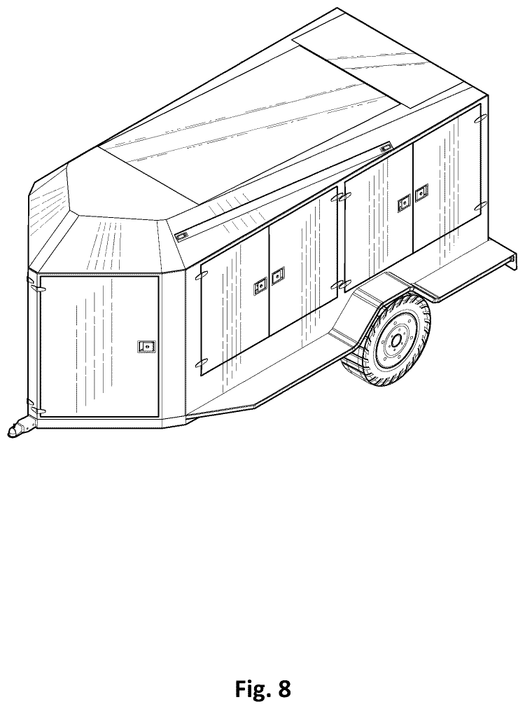

FIG. 8 shows a mobile energy storage and generation system of the present invention.

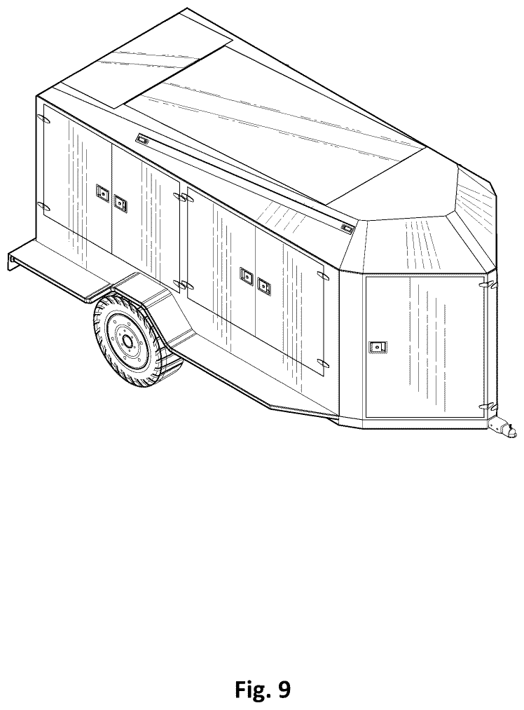

FIG. 9 shows a mobile energy storage and generation system of the present invention.

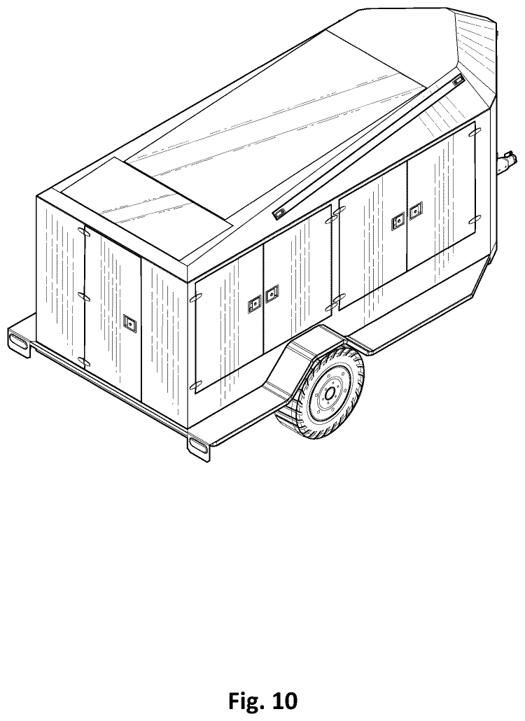

FIG. 10 shows a mobile energy storage and generation system of the present invention.

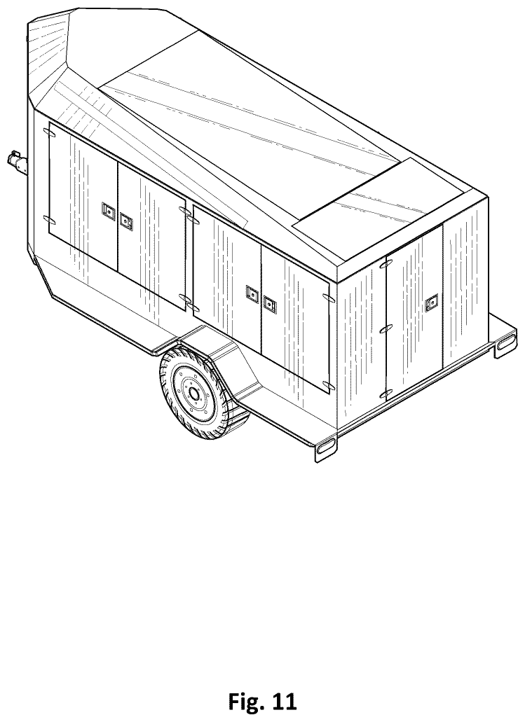

FIG. 11 shows a mobile energy storage and generation system of the present invention.

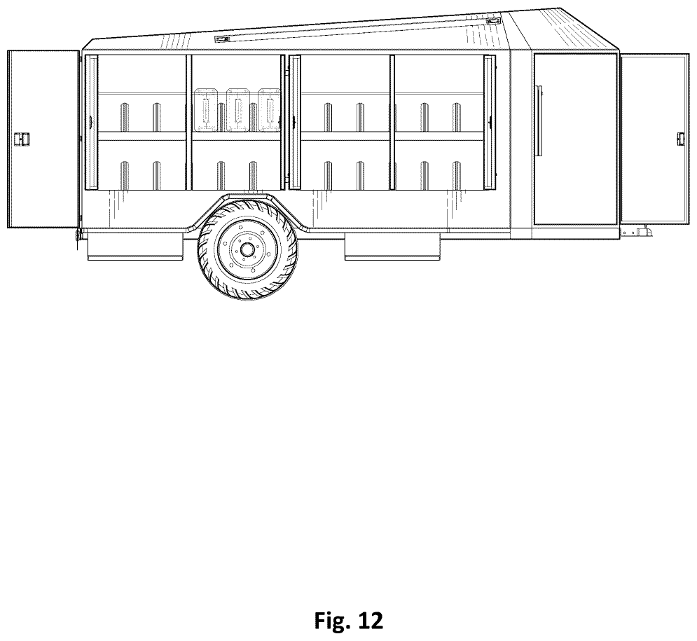

FIG. 12 shows a mobile energy storage and generation system of the present invention.

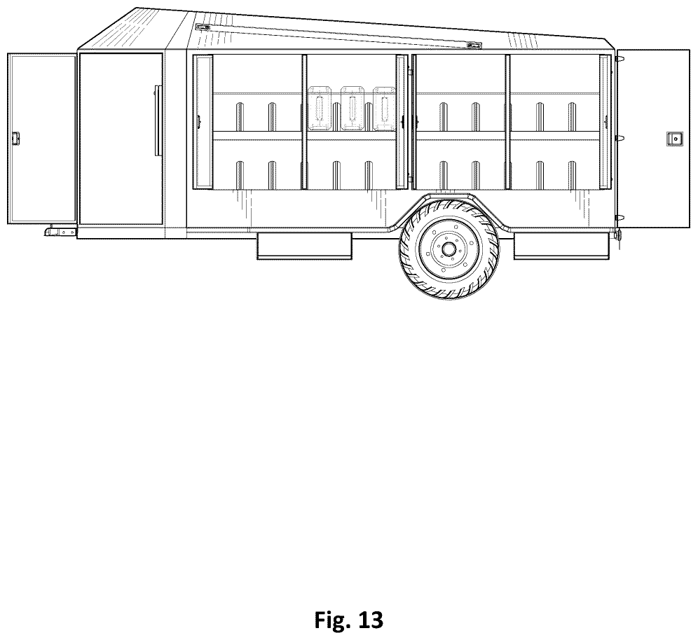

FIG. 13 shows a mobile energy storage and generation system of the present invention.

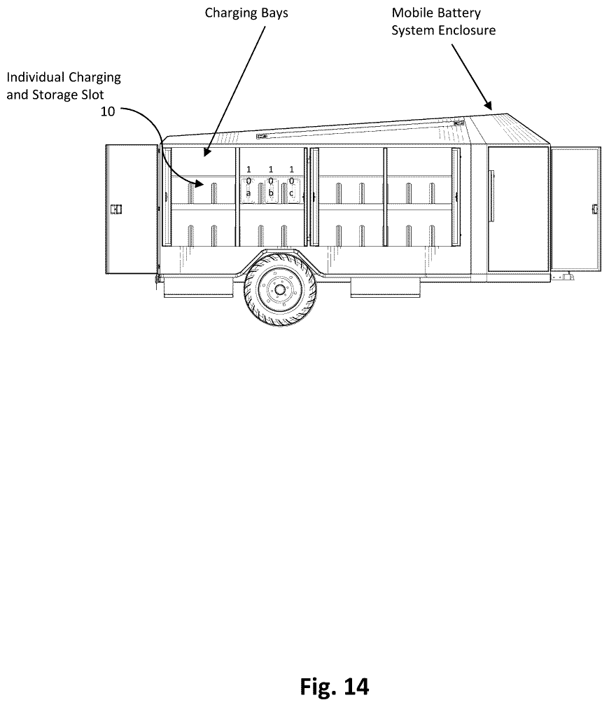

FIG. 14 shows a mobile energy storage and generation system of the present invention.

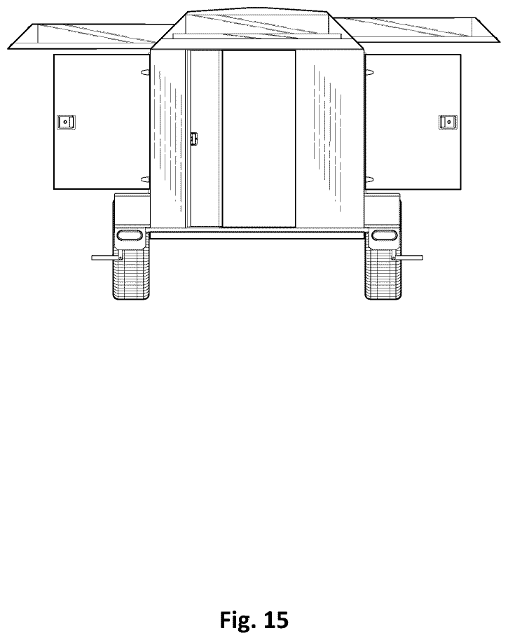

FIG. 15 shows a mobile energy storage and generation system of the present invention.

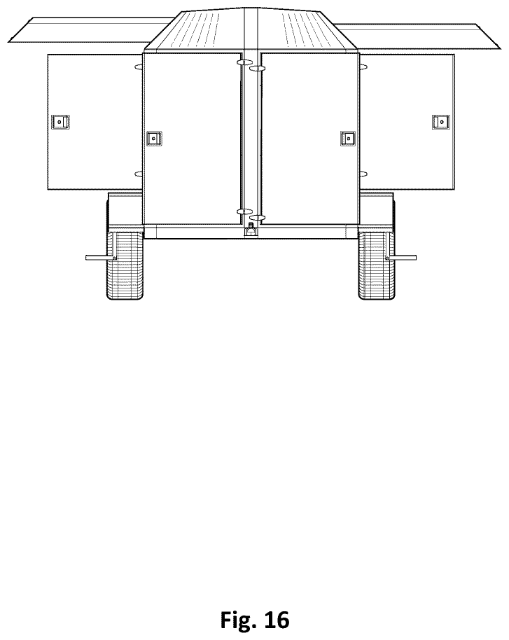

FIG. 16 shows a mobile energy storage and generation system of the present invention.

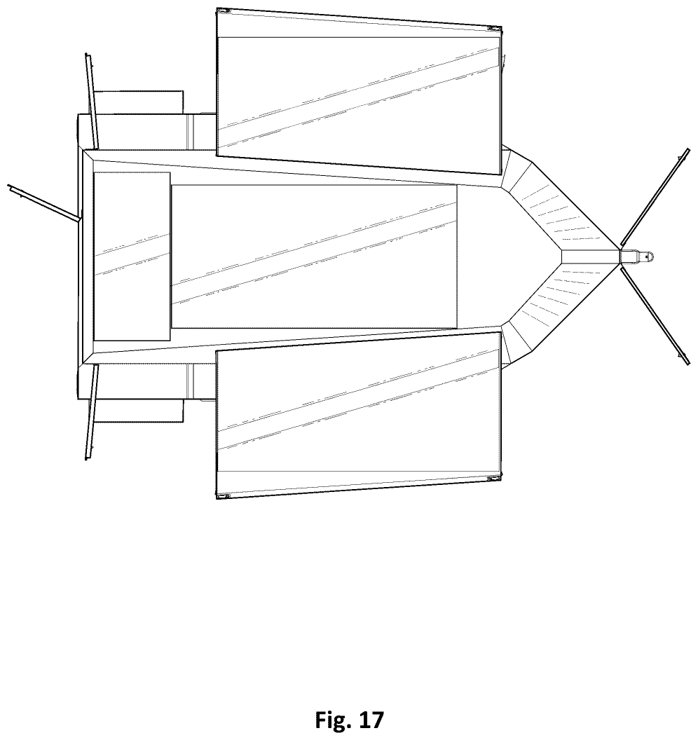

FIG. 17 shows a mobile energy storage and generation system of the present invention.

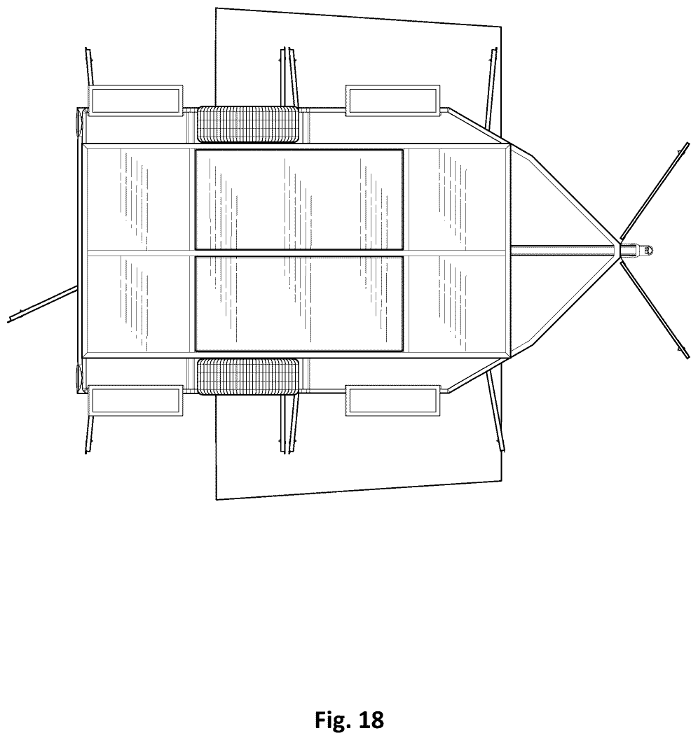

FIG. 18 shows a mobile energy storage and generation system of the present invention.

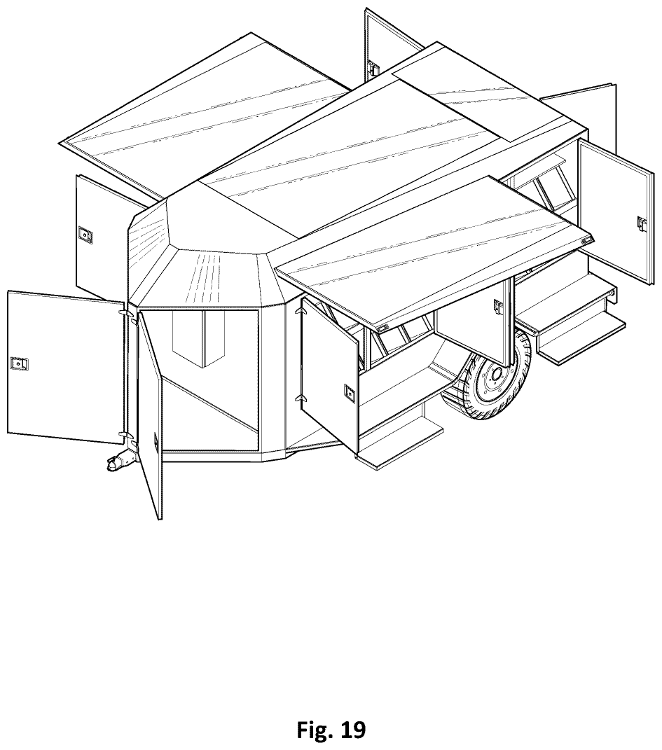

FIG. 19 shows a mobile energy storage and generation system of the present invention.

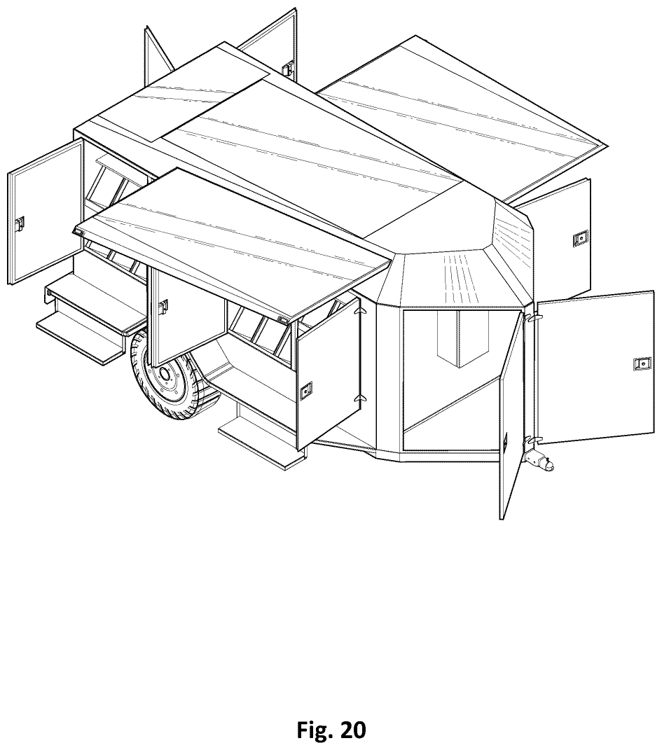

FIG. 20 shows a mobile energy storage and generation system of the present invention.

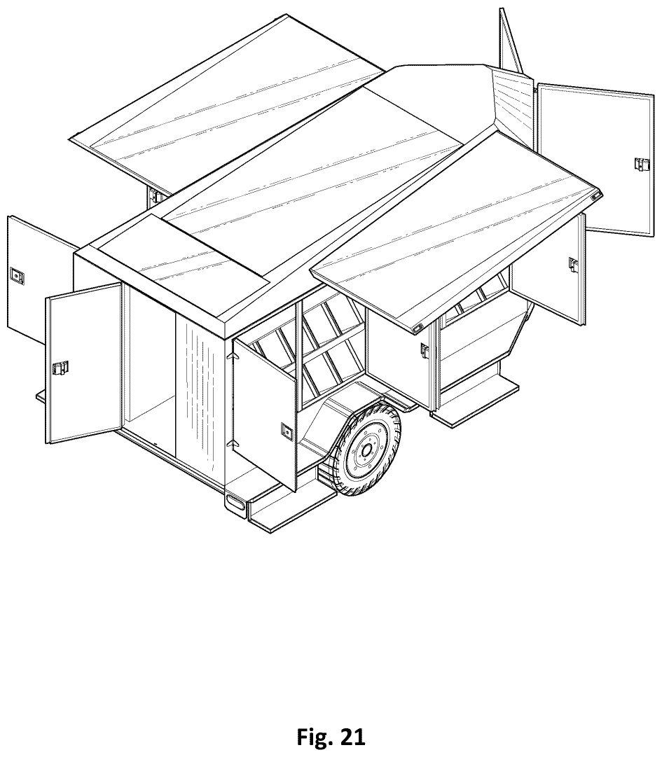

FIG. 21 shows a mobile energy storage and generation system of the present invention.

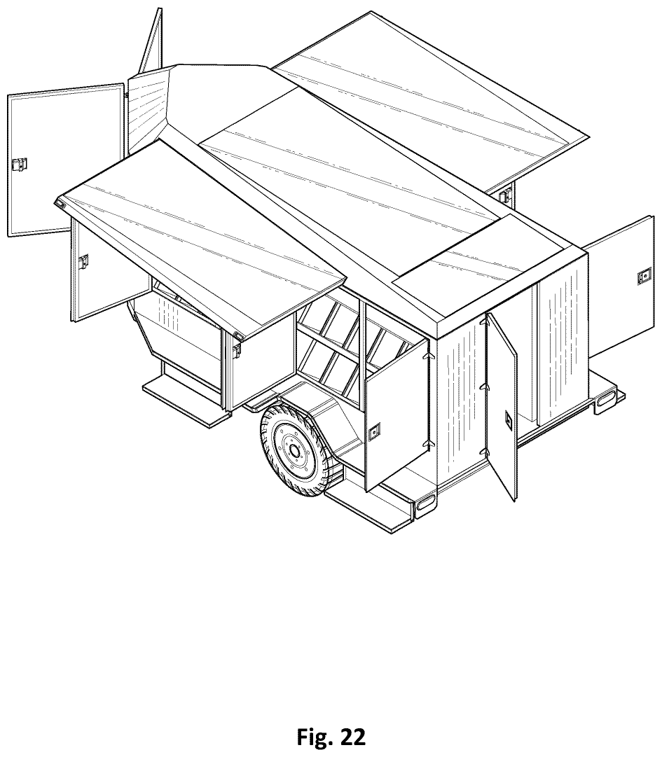

FIG. 22 shows a mobile energy storage and generation system of the present invention.

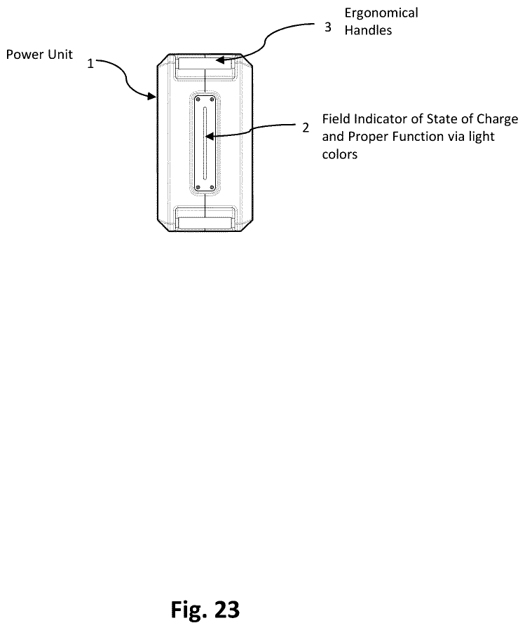

FIG. 23 shows a power unit of the present invention.

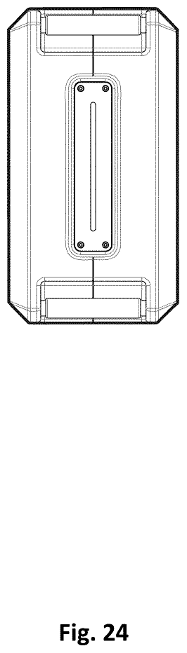

FIG. 24 shows a power unit of the present invention.

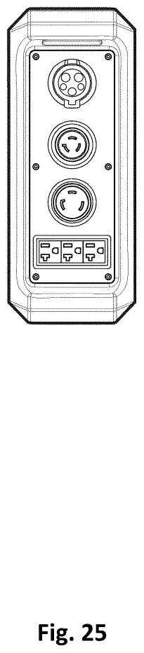

FIG. 25 shows a control unit of the present invention.

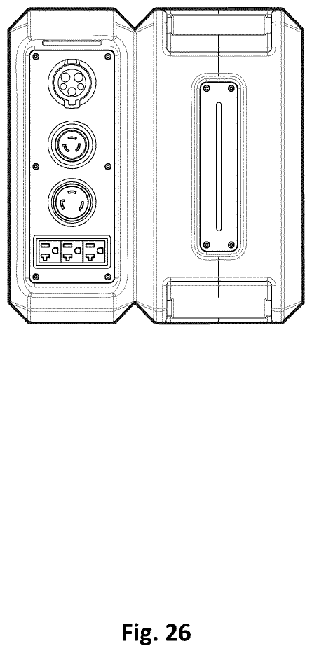

FIG. 26 shows an embodiment of a control unit and a power unit of the present invention.

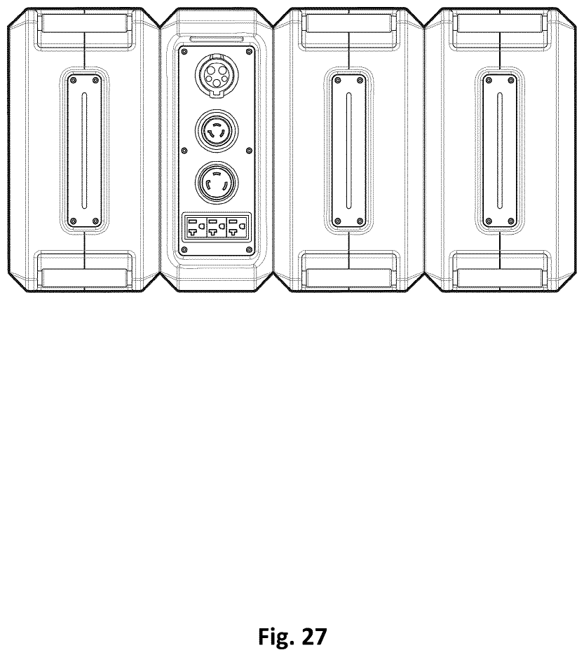

FIG. 27 shows an embodiment of a control unit and a plurality of power units of the present invention.

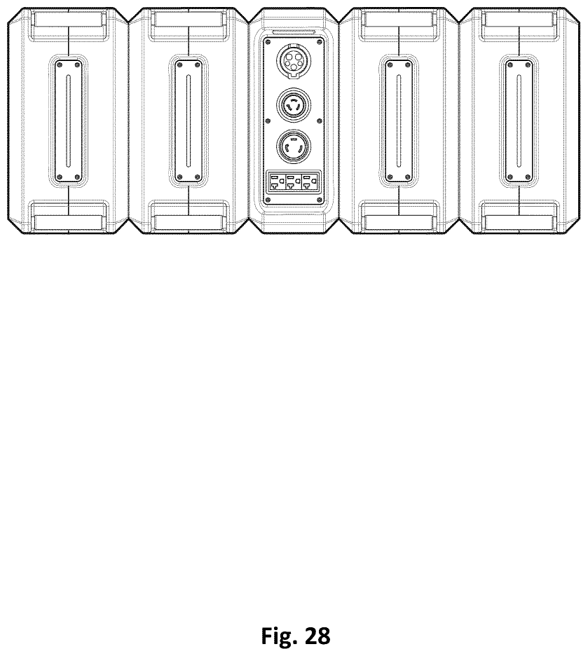

FIG. 28 shows an embodiment of a control unit and a plurality of power units of the present invention.

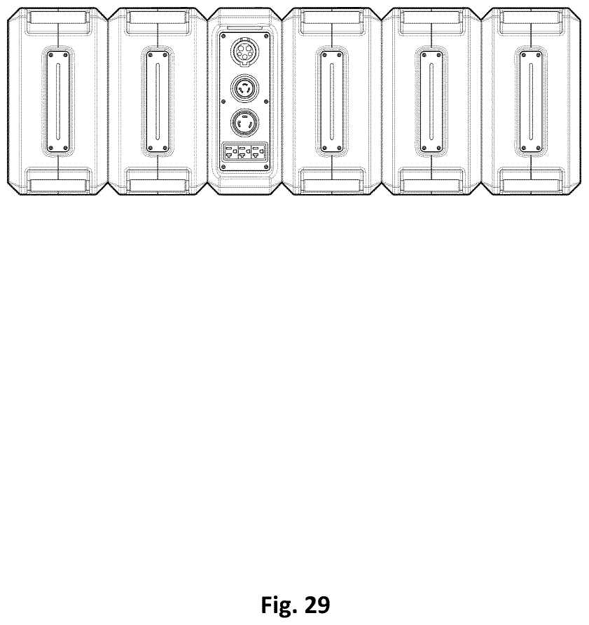

FIG. 29 shows an embodiment of a control unit and a plurality of power units of the present invention.

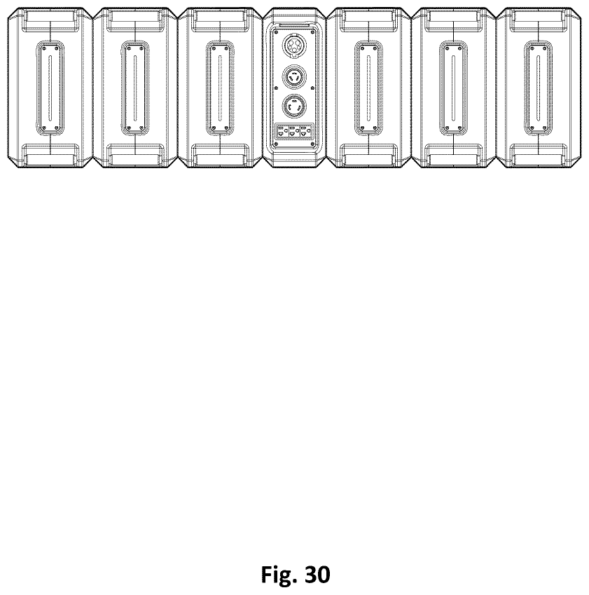

FIG. 30 shows an embodiment of a control unit and a plurality of power units of the present invention.

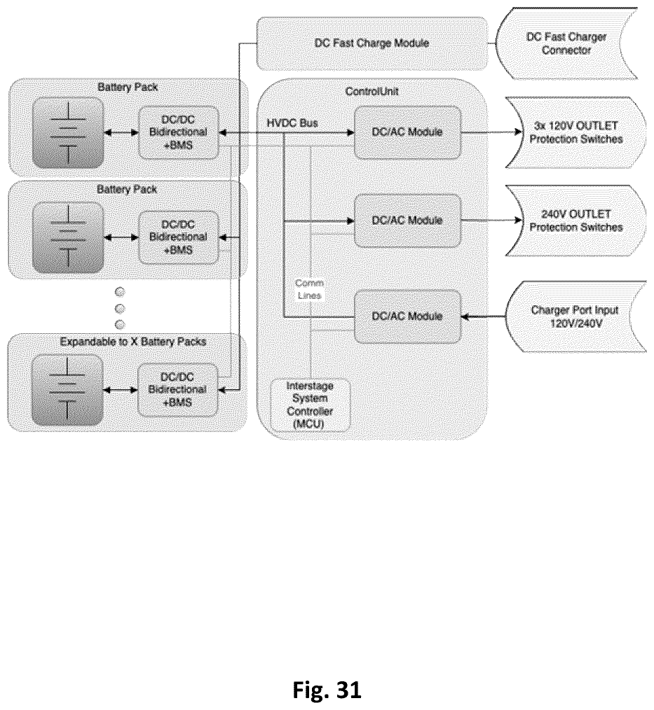

FIG. 31 is a schematic of the of the present invention.

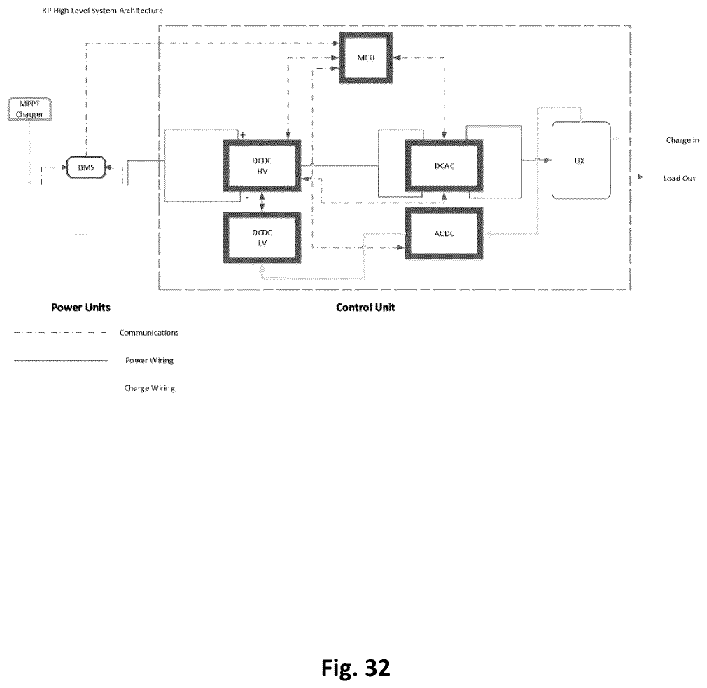

FIG. 32 is a schematic of the of the present invention.

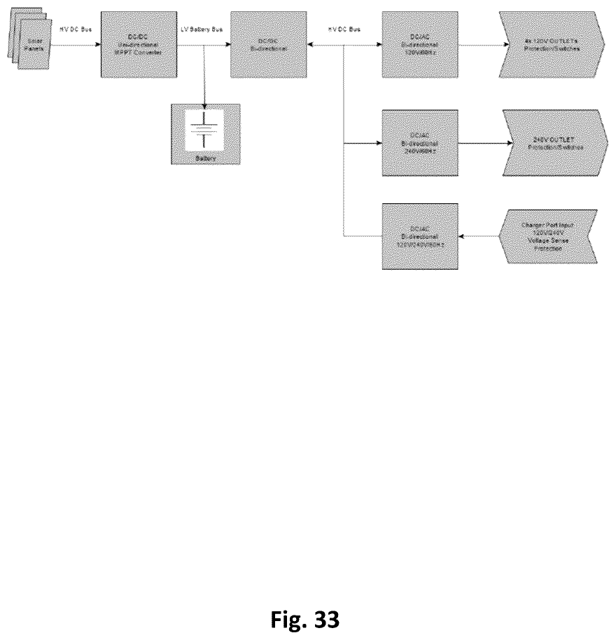

FIG. 33 is a schematic of the of the present invention.

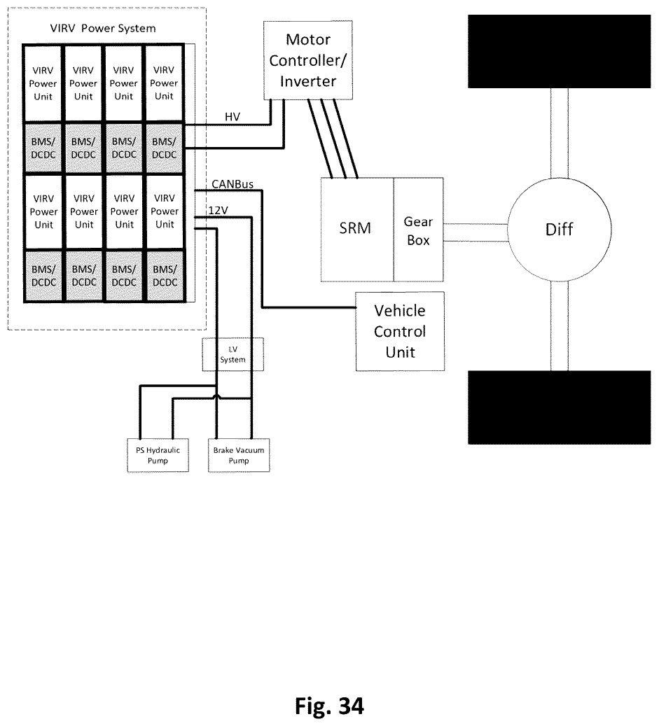

FIG. 34 is a schematic of the of the present invention.

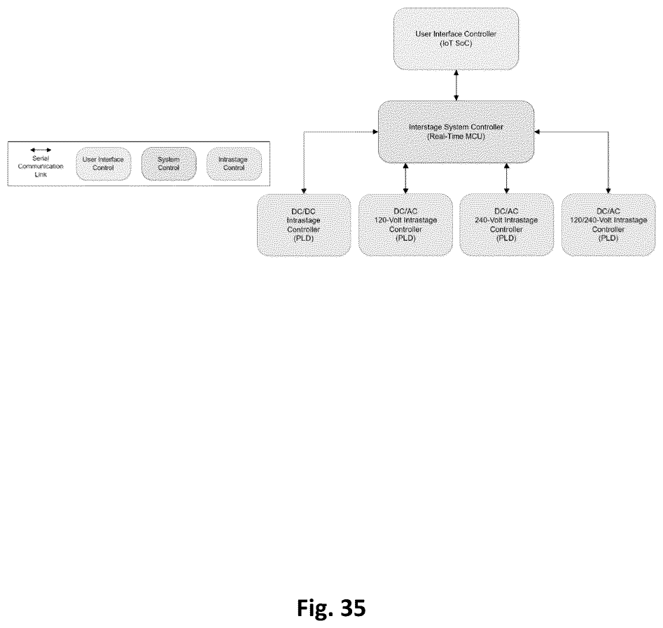

FIG. 35 is a schematic of the of the present invention.

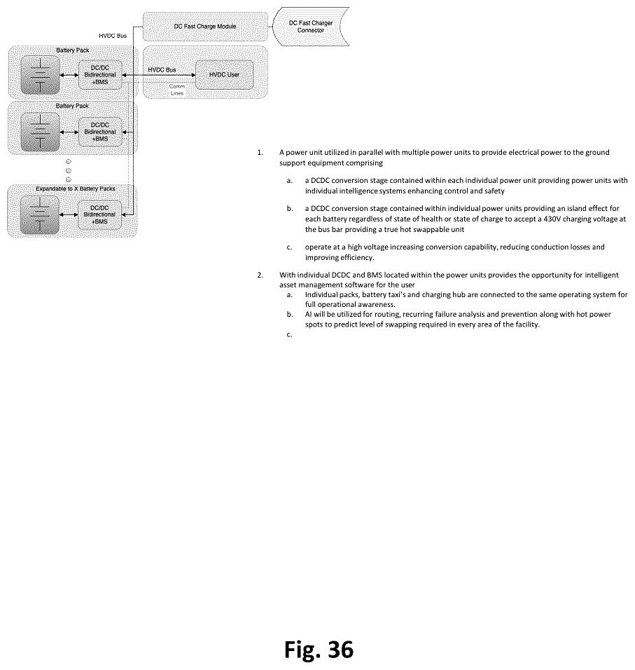

FIG. 36 is a schematic of the of the present invention.

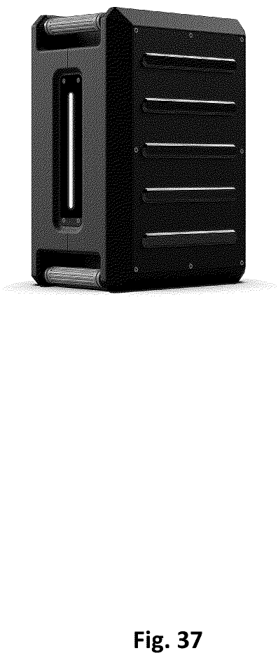

FIG. 37 shows a power unit of the present invention.

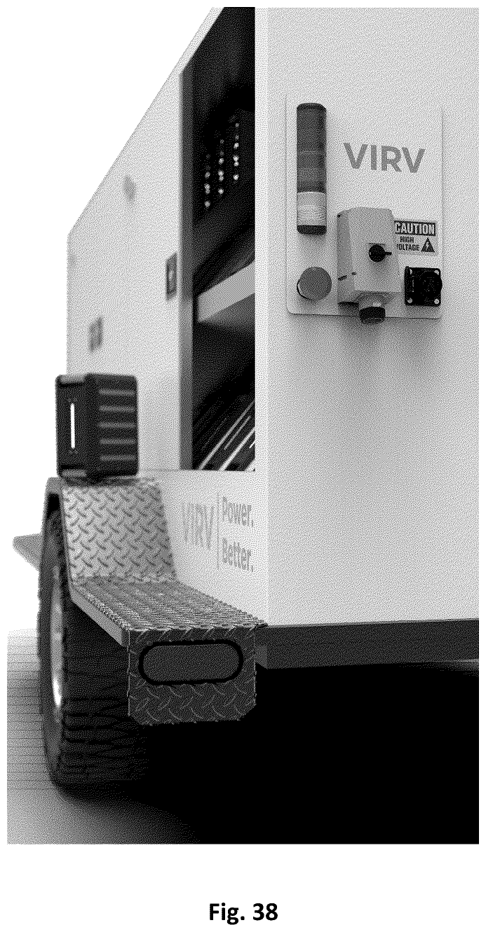

FIG. 38 shows a mobile energy storage and generation system of the present invention.

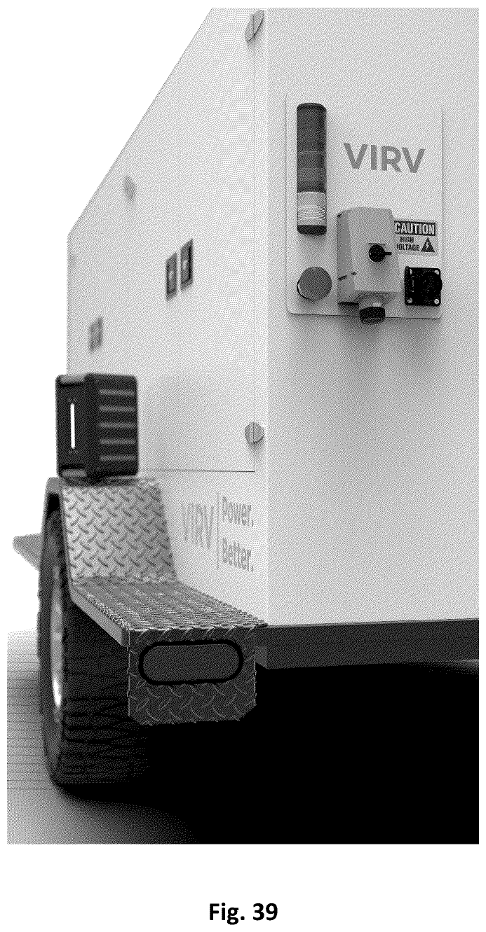

FIG. 39 shows a mobile energy storage and generation system of the present invention.

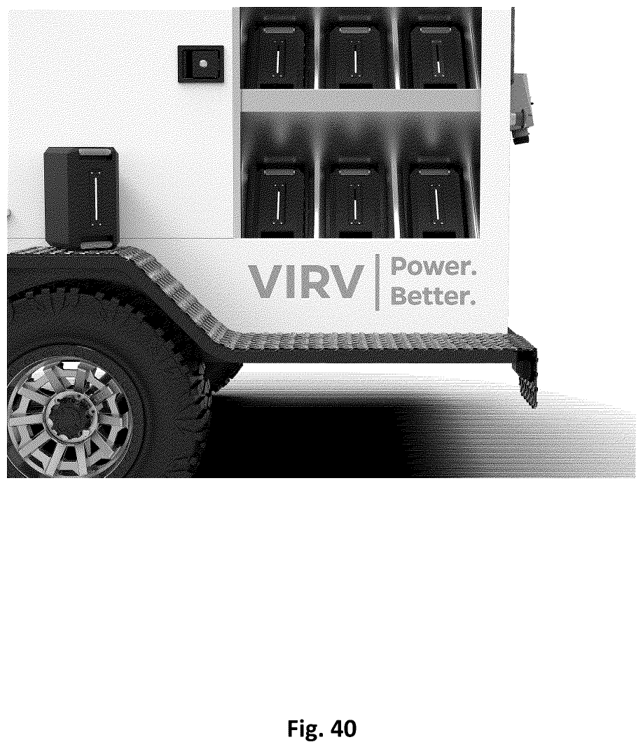

FIG. 40 shows a mobile energy storage and generation system of the present invention.

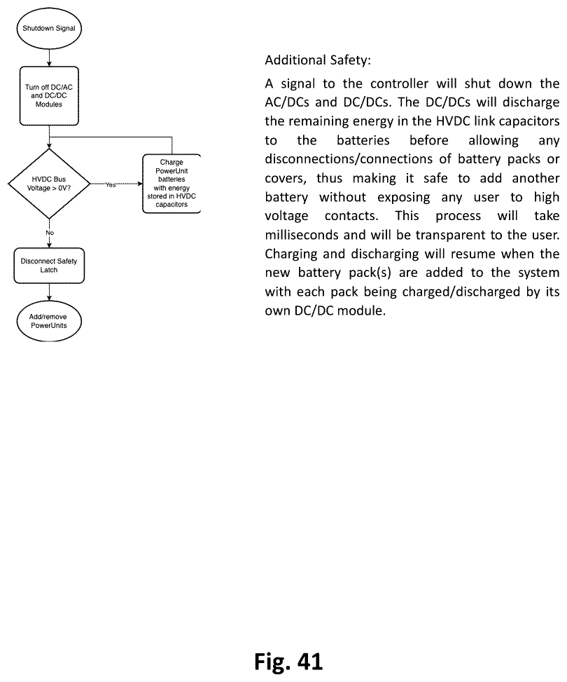

FIG. 41 is a schematic of the of the present invention.

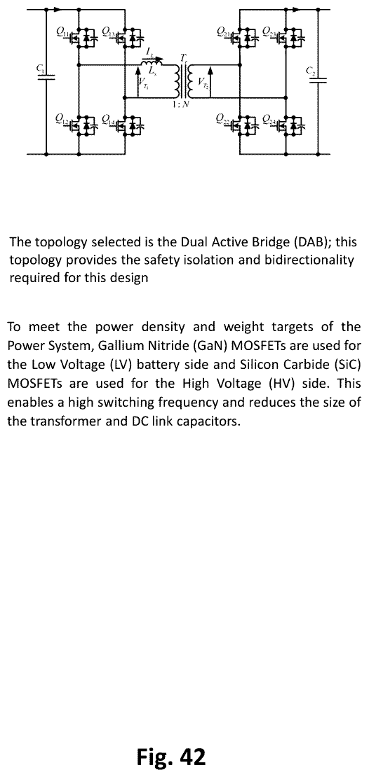

FIG. 42 is a schematic of the of the present invention.

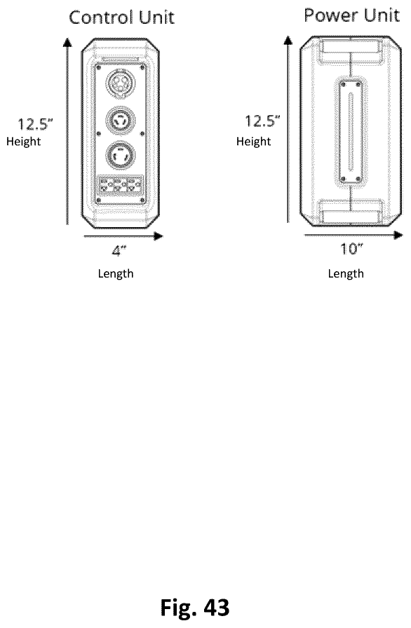

FIG. 43 shows one embodiment of a control unit and one embodiment pf a power unit of the present invention.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Embodiments of the present invention provide an electrical energy storage and power generation device and systems. In some embodiments, the electrical energy storage and power generation device and systems includes a battery/power cell device and system. In some embodiments of the present invention, the battery device and system include a plurality of batteries. In some embodiments, the battery units comprise a lithium-ion battery chemistry; however, other chemistry are contemplated. According to one embodiment, the instant invention includes an electrical power distribution device and systems. In some embodiments, the electrical energy storage and power generation device and systems includes an electrical power electronics device and systems. In some embodiments, the electrical energy storage and power generation device and systems is a mobile electrical energy storage and power generation system. In some embodiments, the electrical energy storage and power generation device and systems is a mobile electrical energy storage and power generation system. In some embodiments, the electrical energy storage and power generation device and systems is a mobile electrical energy storage and power generation system, such as a modular battery taxi.

Referring generally to the Figures, a battery system is disclosed according to some embodiments of the invention. In an exemplary embodiment, the battery system discloses a device and method for storing electrical energy. In some embodiments, the battery system discloses a device and method for generating electrical energy. In other embodiments, the battery system discloses a device and method for converting electrical energy from a source, such as an alternating current (“AC”) grid or other AC electrical source, to direct current (“DC”) power and storing the converted energy in a power cell device and systems.

Referring to FIGS., in some embodiments, the instant invention includes an electrical power input device and systems. The battery system is configured to receive an electrical input, either AC or DC, as an input source or as input electrical power to the battery system. In some configurations of the instant invention, this electrical power is supplied from an AC electrical source and the battery system includes a power electronic system, such as a bidirectional converter system, capable of converting the AC voltage to DC voltage. According to one embodiment of the instant invention, the AC input power is coupled to a DC charging system and DC power distribution system via a power electronics system.

Referring to FIGS., in some embodiments, the instant invention includes an electrical power output device and systems. In some embodiments, the electrical output system is an AC output system providing a plurality of AC voltages, such as 240 VAC. In some embodiments, the electrical output system is an AC output system is configured to supply a single-phase AC voltage. In other embodiments, the electrical output system is configured to supply a three phase AC voltage. In some embodiments, the electrical output system provides a plurality of DC voltages, such as 24 VDC.

Referring to FIGS., in some embodiments, the present invention includes a power distribution system. A power distribution system according to one aspect of the invention is provided via an electrical busway, electrical wiring, or a combination thereof. In some embodiments of the instant invention, at least one power unit is electrically coupled to the power distribution system. In some embodiments of the instant invention, a plurality of power units are electrically coupled to the power distribution system. In some embodiments of the instant invention, at least one control unit is electrically coupled to the power distribution system. In some embodiments of the instant invention, a plurality of control units are electrically coupled to the power distribution system. In some embodiment of the instant invention, the power distribution system includes a multi-voltage electrical bus.

Referring to FIGS., in an exemplary embodiment of the instant invention, the battery system includes a power electronic system that is configured as a bidirectional AC/DC and DC/AC power conversion system. In some embodiments of the present invention, the power electronics system is configured to provide conversion and inversion of power and voltage to the DC charging system and distributed power system. In some embodiments of the instant invention, at least one power unit is electrically coupled to the power electronic system. In some embodiments of the instant invention, a plurality of power units are electrically coupled to the power electronic system. In some embodiments of the instant invention, at least one control unit is electrically coupled to the power electronic system. In some embodiments of the instant invention, a plurality of control units are electrically coupled to the power electronic system. In some embodiments, the battery system includes a plurality of sensors, such as temperature, voltage monitoring, or current sensing sensors.

Referring to FIGS., in an exemplary embodiment of the instant invention, the battery system includes a modular battery device and systems. According to some embodiments, the battery system includes a control system, a battery system communication system, and components, such that the battery system in enabled to function as a standalone system. In other embodiments, the battery system is configured to be used and connected to one or more additionally battery systems.

Referring to FIGS., in an exemplary embodiment of the instant invention, the battery system includes a DC charging system. In some embodiments of the instant invention, a DC charging system includes power electronics to convert AC voltage, DC voltage, or a combination from an electrical input source such that the input power is utilized by the battery system for charging at least one power unit. In some embodiments, the DC charging system provides electrical input power to at least one power unit via an electrical connection, such as an electrical busway or backplane. In some embodiments, the DC charging system provides electrical input power to a plurality of power units via an electrical connection, such as an electrical busway or backplane.

Referring to FIGS., in a preferred embodiment of the instant invention, the battery system includes at least one battery unit. In some embodiments of the instant invention, a battery unit is a power unit. In some embodiments, the battery system includes a plurality of battery units. In some embodiments, the battery unit includes a charge level indicator. In some embodiments, the charge level indicator represents a state of charge for the respective battery unit. In some embodiments, the charge level indicator is a light source, such as a light emitting diode (“LED”). In other embodiments, the charge level indicator includes a plurality of LEDs.

In an exemplary embodiment of the instant invention, the battery system includes a DC conversion stage within each power unit. The DC conversion stage provides the power units with individual intelligence systems, thereby enhancing control and safety. The DC to DC conversion stage contained within each individual power unit provides an island effect for each power unit, despite the state of health or state of charge to accept a 400 volt charging voltage at the electrical connection (e.g., electrical busway) providing a hot swappable power unit.

In some embodiments, the battery unit includes at least one handle. The battery unit handle is made from a suitable material such that the handle can be used to fully support and suspend its respective battery unit. In other embodiments, the battery unit includes a plurality of handles. In some embodiments, the power unit has a capacity of 3,800-watt hours of electrical energy. In some embodiments of the instant invention, a power unit weighs 45 lbs. Referring to FIG. 43 and in one embodiment of the instant invention, the power unit generally includes the dimensions of a height of approximately 12.5 inches; a width of approximately 10 inches; and a depth of 12.5 inches (from a front view perspective). Alternative embodiments include different dimensions but with a height, width and depth of similar proportions to those disclosed above.

Referring to FIGS., in one embodiment of the instant invention, the battery system includes at least one battery control unit. In some embodiments, the control unit includes a plurality of electrical outputs, such as an electrical receptacle or terminal. In other embodiments of the instant invention, the control unit includes a J1772 level output, such as a J1772 adapted utilized for level 1 and level 2 charging of electric vehicles. In other embodiments of the instant invention, the control unit includes a 120 VAC receptacle. In other embodiments of the instant invention, the control unit includes a 240 VAC receptacle. In other embodiments of the instant invention, the control unit includes a combination of AC and DC voltage rated receptacles. Referring to FIG. 43 and in one embodiment of the instant invention, the control unit generally includes the dimensions of a height of approximately 12.5 inches; a width of approximately 4 inches; and a depth of 12.5 inches (from a front view perspective).

Referring to FIGS., the instant invention is configured such that a plurality of power units and a plurality of control units are utilized to form a battery system, such as a modular battery bank and system. In a preferred embodiment, the modular battery system design allows a user to connect and disconnect the power units and control unit for ease of mobility and expansion of energy capacity up to six or more power units.

In some embodiments, a first power unit is connected in parallel with at least one other power unit to provide electrical power to the battery system output. In some embodiments, a first power unit is connected in series with at least one other power unit to provide electrical power to the battery system output. In some embodiments, a first power unit is connected in series and parallel with a plurality of at least one other power unit to provide electrical power to the battery system output. In some embodiments, a first battery system is configured to be connected in parallel with at one other battery system. In some embodiments, a first battery system is configured to be connected in series with at one other battery system.

Referring to FIGS., in some embodiments of the instant invention, the battery system is fully modular and scalable, such that multiple battery units can be electrically connected to a control unit. In some embodiments, a battery system consists of one battery unit and one control unit. In other embodiments, a battery system consists of a plurality of battery units and one control unit. In some embodiments of the instant invention, the battery system includes a plurality of battery units and a plurality of control units. In some embodiments, a battery unit is electrically and mechanically connected to a first side of a control unit. In some embodiments, a battery unit is electrically and mechanically connected to a second side of a control unit. In some embodiments, a first battery unit is electrically and mechanically connected to a first side of a control unit and a second battery unit is connected to a second side of the control unit. In some embodiments, a first battery unit is electrically and mechanically connected to second battery unit. In some embodiments, a first battery unit is electrically and mechanically connected to a plurality of battery units.

In some embodiments, the connections between a battery unit and a control unit are via a busway, such as a copper busway. In some embodiments, the connections between a battery unit and a control unit include a control charging system and electronics. In some embodiments, the connections between a first battery unit and a first control unit include is via a backplane. In some embodiments, the connections between a plurality of power units is via a backplane. In some embodiments, the connections between a plurality of control units is via a backplane.

Referring to FIGS., in a preferred embodiment, the battery system is configured to be hot swappable. The power unit system of the instant invention are configured and designed to be quickly disconnected and/or reconnected without having to lose or turn off power to the remaining power units and the power distribution system of the instant invention. In some embodiment of the instant invention, the electrical control system is configured to allow power unit insertion/disconnection into the battery system without harming damaging existing power units or the newly instead power unit.

Referring to FIGS., in a preferred embodiment, the instant invention is a mobile battery system, such as a battery taxi system. Still referring to FIGS., in some embodiments, the mobile battery system includes a mobile vehicle that further includes a frame and an enclosure. In some embodiments, the frame of the mobile battery system is configured to support the enclosure and the battery system such that it may be utilized to provide a portable electrical power system. In a preferred embodiment, the above-described battery system is configured to be a mobile battery power generation and storage system.

In some embodiments, the mobile battery system includes a frame that is configured to enable the mobile battery system to be a portable/transport electrical power and generation system. In other embodiments, the frame is configured to support an enclosure.

In some embodiments, the mobile vehicle frame includes a tow hitch being configured to attach to another mobile vehicle. In an exemplary embodiment, the mobile battery system includes a container that provides access to the AC and DC output power via an electrical panel.

In some embodiments, the mobile battery system frame is supported by two or more ground supporting members, ground supporting members such as tires. In some embodiments, the mobile battery system includes one or more wheels/tires.

Referring to FIGS., in some embodiments, the mobile vehicle enclosure is arranged on the frame, wherein a plurality of power units are arranged within an interior area defined by the enclosure.

In some embodiments, the mobile battery system enclosure comprises several access panels for accessing an interior area of the enclosures. According to one embodiment of the instant invention the door access panels are movable from a first position to a second position. In some embodiments of the instant invention, the access panels are movable from a closed position to an open position.

In some embodiments, the interior area of the enclosure of the instant invention defines a charging bay. As illustrated by the drawings, in some embodiments the mobile battery system enclosure defines several charging bays, the charging bays being configured to provide a secure storage slot for the power units and/or the control units. In some embodiments of the instant invention, a slot is configured to securely hold a power unit in place and connected to the battery system while the mobile battery system is being transported. In some embodiments of the instant invention, a slot is configured slightly larger than the power units, while being configured to securely hold a power unit in place and connected to the battery system. In some embodiments of the instant invention, a slot is configured to securely hold a control unit in place and connected to the battery system while the mobile battery system is being transported. In some embodiments of the instant invention, a slot is configured slightly larger than the power units, while being configured to securely hold a control unit in place and connected to the battery system.

Referring to FIGS., in some embodiments, the mobile battery system includes a plurality of secure storage slots for the power units and/or the control units. In a preferred embodiment, the power units are placed into an individual slot and further connected to a backplane, wherein the backplane provides a mechanical and electrical connection to the power unit. In some embodiments, the backplane comprises a power distribution system. In other embodiments, the backplane includes an electrical control system. A backplane according to the instant invention is a backplane that is configured to control the input and output from at least one power unit. In some embodiments, the backplane includes a power distribution system and electrical control system that further defines a system that provides an electrical connections to a plurality of power units placed within the mobile battery system.

Referring to FIGS., in some embodiments of the instant invention, the mobile power system includes a photovoltaic (“PV”) system to provide power for charging/recharging batteries within the system. In some embodiments, the mobile power system is capable of being connected to an external power supply (such as a generator or to the electrical grid) to provide power for charging/recharging batteries within the system. In a preferred embodiment, a solar panel of the PV system is mounted partially on the mobile battery system enclosure roof. In some embodiments, the roof mounted solar panel is retractable and movable from a first position to a second position. According to one embodiment, the PV solar panel is movable from an outer roof area of the enclosure to an interior area of the mobile battery system enclosure. In a preferred embodiment, the PV system is electrically connected to the mobile battery systems power distribution and control system. In some embodiments, the PV provides a source of electrical power to charge at least one of the power units.

Referring to FIG., and in some embodiments, the mobile battery system includes an enclosure that provides access to the AC and DC output power via an electrical panel.

Referring to FIG., in some embodiments the mobile battery system is configured as a mobile vehicle that is movable and self-powered (e.g., an aircraft towing vehicle). In some embodiments, the present invention includes a regenerative braking system to provide charging power to at least one of the power units.

In some embodiments, the instant invention is a mobile, modular battery system, such as a battery taxi, configured to support a swappable battery as a service platform. In some embodiments, the instant invention includes a DC charging system coupled to an AC grid connection or a photovoltaic system or a flexible fuel generator system or another type of renewable energy distributed generation systems such as Hydrogen. In some embodiments, the instant invention includes a power electronics system configured for and providing conversion and inversion of power and voltage to the DC charging system and distributed power system. In some embodiments, the instant invention includes a DC energy storage system contained within the frame of the unit. In some embodiments, the instant invention includes a DC energy storage system contained within the mobile battery system enclosure of the instant invention. In some embodiments, the instant invention includes an AC output system providing single phase 240 VAC with the option of 480 VAC three-phase. In some embodiments, the instant invention includes a DC output power system. In some embodiments, the instant invention includes a secure storage and charging slot with an electromechanical connection to provide charge to each individual power unit.

In some embodiments, the instant invention includes a retractable wing PV system connected to the roof of the distributed power and energy storage system. In some embodiments, the instant invention includes a tongue storage container providing user access to the AC and DC output power system via electrical panel. In some embodiments, the instant invention includes a power unit utilized in parallel with multiple power units to provide electrical power to the ground support equipment. In some embodiments, the instant invention includes a DC to DC conversion stage contained within each individual power unit providing power units with individual intelligence systems enhancing control and safety.

In some embodiments, the instant invention includes a DC to DC conversion stage contained within individual power units providing an island effect for each battery regardless of state of health or state of charge to accept a 400V charging voltage at the bus bar providing a true hot swappable unit. In some embodiments, the instant invention operates at a high voltage increasing conversion capability, reducing conduction losses and improving efficiency. In some embodiments, the mobile, modular battery taxi in wherein the DC charging system contains power electronics to accept 480 VAC three-phase grid power then invert the AC to DC and convert the DC to DC at a voltage to provide charging power to the individual distributed power units. In some embodiments, the mobile, modular battery taxi wherein the DC charging system contains power electronics to accept VDC power from retractable wing photovoltaic system and convert the DC to DC at a voltage of 400V to provide charging power to the individual distributed power units. In some embodiments, where the retractable PV system can be expanded thru the addition of more panels whether affixed or ground mounted. In some embodiments, the instant invention includes the DC charging system contains power electronics to accept VDC or VAC power from a flexible fuel generator system and convert the DC to DC at a voltage to provide charging power to the individual distributed power units.

In some embodiments, the instant invention includes the mobile, the DC energy storage system is co-located with the frame of the trailer. In some embodiments, the instant invention at least one battery units is electrically coupled to the DC charge system to accept charging power. In some embodiments of the instant invention, the DC charging system is electrically coupled to the AC and DC output power systems. In some embodiments, the AC power system is electrically coupled to the DC charge system and DC distributed power system via the power electronics system. In some embodiments, the instant invention includes single phase 240 VAC output system provides electrical connections for user applications. In some embodiments, the instant invention the DC distributed power units are electromechanically coupled to the DC charge system to accept charge power as described herein. In some embodiments, the instant invention includes electrically coupled to the power electronics system for inversion from DC to AC current providing AC output power system with clean sine wave power at 240 VAC single phase

In some embodiments, the instant invention includes Electromechanical connection provides a secure storage attribute to ensure only approved users of the distributed power system are able to access the power units. In some embodiments, the instant invention includes, the mobile, modular battery taxi wherein the user interface application is connected via Bluetooth to Interstage system controller. In some embodiments, the instant invention includes, each stage in the power electronics system is connected via a controller to the Interstage system controller providing real time data to the user interface application. In some embodiments, the instant invention includes The DC charging system described is electrically coupled with a bidirectional DC/DC converter providing pull and push capabilities for energy flow either to the DC charging system or back to the grid power connection.

In some embodiments, with individual DCDC and BMS located within the power units provides the opportunity for intelligent asset management software for the user. In some embodiments, individual battery packs, battery taxi's and charging hub are connected to the same operating system for full operational awareness. In some embodiments, artificial intelligence (“AI”) will be utilized for routing, recurring failure analysis and prevention along with hot power spots to predict level of swapping required in every area of the facility.

In some embodiments, the instant invention includes an 2nd Life Application (i.e., once individual power units have reached 80% maximum capacity due to natural degradation; placed into less power demanding vehicles; or other power applications utilizing DC or AC outputs). In some embodiments, the power units can be coupled with an AC inversion system to power tool, task and teams. In some embodiments, at least some mechanical energy from the mobile electrical system is used to electrically charge the power units, via a mechanical to electrical conversion system. In some embodiments, the mobile battery system further includes an optimized battery system voltage (safe-to-touch). In some embodiments, the present invention includes a DC/DC Bi-Directional Dual Active Bridge Converter to boost battery voltage to a stable high-voltage DC (Direct Current) link. In some embodiments, the present invention includes an optimized Thermal Management that capitalizes on the separation of the power electronics and battery to lower required heat removal. In some embodiments, the present invention includes utilizing a 3-Phase Transformer instead of a Single-Phase Transformer. According to an embodiment, the instant invention provides advantages that include lower peak switching currents (fewer switching devices), lower phase leg current (less losses in the transformer), smaller ripple currents in output (reduced capacitance required). In some embodiments, the present invention includes the use of FPGAs versus Microcontrollers. With the high-switching frequencies and number of required switches, FPGAs allow for precision-timed outputs and increased processing flexibility. In some embodiments, the present invention includes layered software control. In some embodiments, the present invention is Bluetooth and/or Wi-Fi-enabled for easy data transfer and technical support regarding battery and system usage diagnostics and/or software and firmware updates.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A mobile electric power storage and generation system, the mobile electric power storage and generation comprising:
a modular battery system;
a frame; and
an enclosure.

2. The mobile electric power storage and generation system of claim 1, wherein the modular battery system comprises:
a plurality of power units; and
a plurality of control units.

3. The mobile electric power storage and generation system claim 1, wherein the modular battery system is configured as a swappable battery as a service platform.

4. The mobile electric power storage and generation system claim 1, wherein the mobile electric power storage and generation system further comprises:
an alternating current input system;
a direct current input system;
an alternating current output system; and
a direct current output system.

5. The mobile electric power storage and generation system claim 1, wherein the mobile electric power storage and generation system further comprises:
a power electronic system, wherein the power electronic system is configured for electrical power conversion and inversion; and
a direct current charging system;
a power distribution system; and
an electrical control system.

6. The mobile electric power storage and generation system claim 1, wherein the enclosure is supported by the frame.

7. The mobile electric power storage and generation system claim 1, wherein the mobile electric power storage and generation system further comprises a plurality of battery bays.

8. The mobile electric power storage and generation system claim 7, wherein the plurality of battery bays comprise a plurality of battery slots.

9. The mobile electric power storage and generation system claim 8, wherein the plurality of battery slots are configured as a power unit slot, wherein at least one of the power unit slot includes an electro mechanical connection to provide charge power to at least one power unit, and wherein at least one of the power unit slot is a secure storage slot.

10. The mobile electric power storage and generation system claim 9, wherein the plurality of battery slots are configured as a control unit slot, wherein at least one of the control unit slot includes an electro mechanical connection to provide an electrical connection to at least one control unit, and wherein at least one of the control unit slot is a secure storage slot.

11. The mobile electric power storage and generation system claim 1, wherein the mobile electric power storage and generation system further comprises a solar charging system.

12. The mobile electric power storage and generation system claim 11, wherein the solar charging system is electrically connected to the electric power storage and generation system.

13. The mobile electric power storage and generation system claim 12, wherein the solar charging system is retractable.

14. The mobile electric power storage and generation system claim 1, wherein the mobile electric power storage and generation system is a towable vehicle.

15. The mobile electric power storage and generation system claim 1, wherein the mobile electric power storage and generation system is a vehicle that is configured as a drivable vehicle.

16. A modular battery system comprising:
a DC charging system;
a first battery unit;
a first control unit; and
an output power system.

17. The modular battery system of claim 16, wherein the modular battery system further comprises a DC to DC conversion stage contained within each individual power unit providing power units with individual intelligence systems enhancing control and safety.

18. The modular battery system of claim 16, wherein the modular battery system further comprises a DC to DC conversion stage contained within individual power units providing an island effect for each battery regardless of state of health or state of charge to accept a 400V charging voltage at the bus bar providing a true hot swappable unit.

19. The modular battery system of claim 16, wherein the modular battery system is configured to operate at a high voltage increasing conversion capability, reducing conduction losses and improving efficiency.

20. The modular battery system of claim 16, wherein the modular battery system further comprising an electrical input system.
